(19) United States
(12) Patent Application Publication
(10) Pub. No.: US 2003/0070693 A1
(43) Pub. Date: Apr. 17, 2003

(54) Method for cleaning and injection mold

(76) Inventors: Scott Stratford, Alta Loma, CA (US); Christopher Allen, Toronto (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/976,024

(22) Filed: Oct. 15, 2001

(51) Int. Cl. B08B 7/00

(52) U.S. Cl. 134/7

(57) ABSTRACT

A method and apparatus of using a dry ice blasting system to clean injection molds in and out of an injection molding machines characterized in that it is easy to use and is particularly well suited to cleaning small mold features such as the vents on molding inserts.

### BACKGROUND OF THE INVENTION

1. Field of the Invention

The field of the invention broadly relates to the maintenance of an injection mold. More specifically, the invention relates to a method and apparatus for cleaning an injection mold.

2. Related Prior Art

The production of consistent quality molded articles from an injection mold requires proper cleaning and maintenance of the tool. Most of the cleaning requirement comes from the cumulative buildup of molding residues from normal mold operation, however cleaning may also result from other events such as mold flashing.

Of particular importance is the cleaning of the mating surfaces and air vents on the mold inserts that form the molding cavity. Improper fit between adjacent inserts relating to excessive residue on the mating surfaces may lead to among other things mold flash. Similarly, excessive residue on mold vents may impede the exit flow of gases during injection that may lead to among other things burn marks, short-shots, and voids.

The critical surfaces of an assembled injection mold do not always lend themselves to cleaning with prior art methods as they may not be easily accessed. Moreover, many of these critical surfaces are easily damaged from vigorous cleaning with abrasive materials.

Injection molds for the production of preforms exemplify these issues. A preform is an intermediate articles used for blow molding into a bottle. In particular, it is difficult to gain access to the core vents or to clean the corresponding mating flange on the neck rings on an assembled preform mold.

A common prior art practice for cleaning exposed surfaces of an assembled injection mold uses a rotationally actuated bristle brush. The brush bristles being made quite stiff but from a necessarily soft material to avoid scratching or otherwise damaging the mold inserts. This approach has proven to be effective in cleaning exposed areas, however is not well suited to clean many critical areas that are not directly accessible.

Another common prior art practice for cleaning exposed surfaces of an assembled injection mold uses simple manual working with a mildly abrasive scouring pad. There are many commercial scouring pads available that are used for cleaning injection molds, however those that tend to be effective in cleaning debris may also be capable of causing some amount of damage to the molding insert if not used with extreme care. This method and apparatus has proven capable of cleaning exposed surfaces, however is not well suited to clean many critical areas that are not directly accessible.

Another prior art mold cleaning method and apparatus is disclosed in U.S. Pat. No. 4,486,238 to Bando, incorporated herein by reference, wherein vibrating brushes are used to remove residual plastic stuck to the metal mold faces. This method and apparatus while capable of cleaning exposed surfaces is not well suited to clean many critical areas that are not directly accessible.

Dry ice blasting is known to be an effective physical method of mechanically removing residue from an injection mold. U.S. Pat. No. 5,932,026 to Trampusch, incorporated herein by reference, teaches a method of cleaning a rubber tire mold using dry ice wherein with the aid of a carrier medium, e.g. air or Nitrogen, the dry-ice pellets are blasted via a cleaning nozzle against the component to be cleaned.

The prior art dry ice systems are limited in that they do not provide the long and slender nozzle configuration required to access the hard to reach areas on an injection mold, the nozzle discharge stream does not have the appropriate properties (i.e. small granule size, low air-to-ice mass flow ratio, and low flow rate) required to clean the smaller features on the mold surface. Prior art systems tend to be noisy, bulky and generally not well configured for use in cleaning injection molds.

The nominal size and general size distribution of dry ice granules directly influences the proper operation of the nozzle in a dry ice blasting system. U.S. Pat. No. 5,520,572 to Opel et al., incorporated herein by reference, discloses the granulation of dry ice from both block and pelletized ice.

### SUMMARY OF THE INVENTION

A primary advantage of the present invention is a nozzle configuration that provides for cleaning in tight areas that would not otherwise be accessible.

Another advantage of the present invention is the ability to clean smaller targets than with the prior art.

Another advantage of the present invention is that the granule size range is small enough to easily penetrate into the vents of the molding inserts.

Another set of advantages of the present invention relate to the lower airflow and results in less sound pressure, reduced air consumption thereby lowering compressor costs, reduced thrust thereby making the hand tool easier to manipulate, reduces air diversion away from the target area.

Another advantage of the present invention is an ergonomic hand tool for housing the nozzle that provides for its rapid maneuver between mold cavities in a multi-cavity mold.

One aspect of the invention is a method for the cleaning of an injection mold comprising the steps of: opening the mold; setting the control parameters of a dry ice delivery system to produce dry ice granules at a gas-to-dry-ice ratio and at specified flow rate; and positioning a nozzle tip of said dry ice delivery system from the surface to be cleaned.

In addition, the method of cleaning an injection mold further comprises the step of positioning a mold ejection mechanism to expose a surface to be cleaned.

In addition, the injection mold is mounted in an injection molding machine and the step of opening the injection mold is performed by stroking a machine platen to maximize the daylight between the mold halves.

In addition, the method of cleaning an injection mold further comprises the step of setting the dry ice delivery system operating parameters to produce dry ice granules preferably within the range of 0.005 to 0.040 inches in diameter.

In addition, the method of cleaning an injection mold further comprising the step of setting the dry ice delivery system operating parameters to maintain a gas to dry ice ratio preferably between 2.0 and 3.5.

In addition, the method of cleaning an injection mold further comprising the step of setting the dry ice delivery system operating parameters to maintain a gas flow rate preferably between 3 and 50 SCFM.

Alternatively, the method of cleaning an injection mold further comprising the step of positioning a nozzle tip of the dry ice delivery system preferably between 0.5 and 1.5 inches from the surface to be cleaned.

In addition, the size of dry ice granules is preferably set to 0.020 inches in diameter.

In addition, the gas to dry ice ratio is preferably set to 3.0;

In addition, the gas flow rate is preferably set to 25 SCFM.

In addition, the position of the nozzle tip relative to the surface to be cleaned is preferably set to 1.0 inches.

In addition, the method of cleaning may be used with an injection mold for the production of preforms.

A second aspect of the invention is a system for cleaning an injection mold comprising a dry ice delivery system and a hand tool. The dry ice delivery system provides a flow of dry ice granules in a gas suspension to a discharge port and in turn to the nozzle of a hand tool wherein the dry ice delivery system is operable to: produce dry ice granules that are preferably between 0.005 and 0.040 inches in diameter; maintain a gas to dry ice ratio preferably between 2.0 and 3.5; and to maintain a flow rate preferably between 3 and 50 SCFM.

In addition, the nozzle diameter is preferably between 0.20 and 0.60 inches in diameter.

In addition, the nozzle length is preferably between 2.5 and 8.0 inches.

In addition, the nozzle diameter is preferably 0.40 inches.

In addition, the nozzle length is preferably 6.0 inches.

In addition, the hand tool includes a pistol grip.

In addition, the angle between the nozzle and the pistol grip is incrementally adjustable.

In addition, the hand tool includes at least one light positioned to cast light in the direction of the nozzle discharge.

In addition, the light is a light emitting diode.

In addition, a valve to control the gas pressure and hence said flow rate is included on the hand tool.

In addition, the cleaning system is suitable for cleaning preform molds.

Another advantage is the present invention allows the operator to clean a mold quicker.

### BRIEF DESCRIPTION OF THE DRAWINGS

FIG. 1 is a schematic representative of an injection mold being cleaned through the use of a dry ice blaster.

### DETAILED DESCRIPTION OF THE PREFERRED EMBODIMENTS

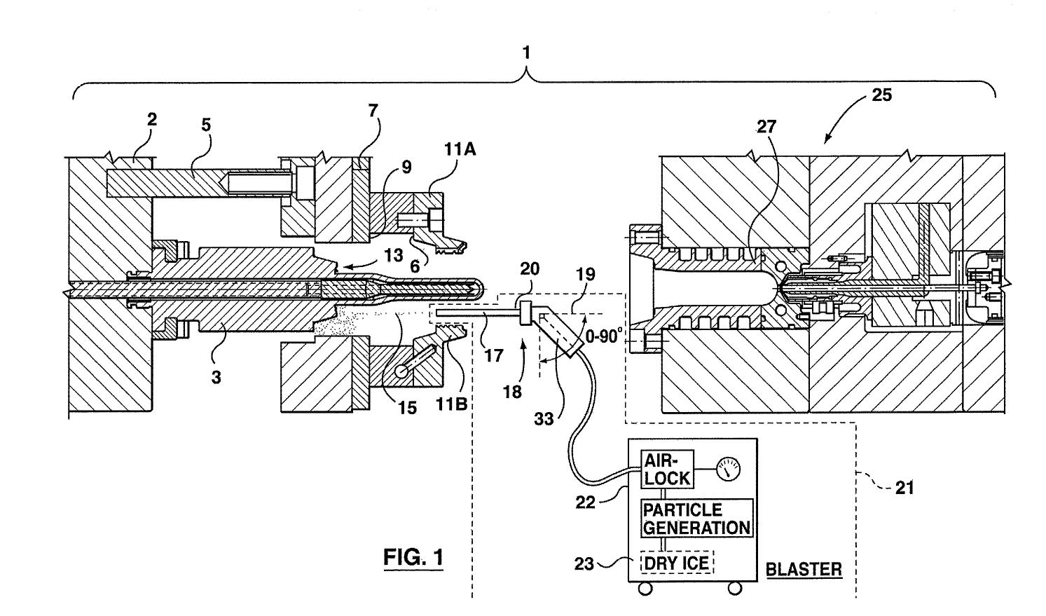

Referring to FIG. 1, a cleaning operation of a preform mold 1 is depicted using a dry ice blasting system 21. The preform mold 1 is shown in an open position with a suitable distance between the respective cold 2 and hot halves 25 with the mold ejection mechanism 5 positioned to reveal core vents 13 and corresponding sealing face 6 on the neck ring pair 11A & 11B. The nozzle clearance 29 for the hand tool nozzle 17 for the majority of multi-cavity preform molds 1 is in the range of 0.20 to 0.60 inches, with 0.40 being typical. The nozzle construction employs a venturi construction to accelerate the dry ice particles. In order to avoid clogging in the nozzle 17 the dry ice granule size must be less than the diameter at the narrowest region of the nozzle at its throat. It has been determined that the optimal granule size for a low flow stream 15 is preferably between 0.005 and 0.040 inches in diameter, with particle sizes of less than 0.020 being typical. The corresponding gas-to-ice ratio preferably being between 2.0 and 3.5, with a value of 3.0 being typical. A low flow stream has a gas flow rate preferably between 3 and 50 SCFM, with a value of 25 being typical. For optimal cleaning the cleaning distance 31 between the nozzle tip and the surface to be cleaned (e.g. vent 13) is preferably between 0.5 and 1.5 inches, with a value of 1.0 inch being typical. In order to accommodate the cleaning distance 31 and not have the pistol handle of the hand tool 19 interfere with the neck rings 11A & 11B, the nozzle length is preferably between 2.5 and 12.0 inches, with a length of 6.0 inches being typical.

The hand tool 19 further includes a pistol grip 33 that has a pivoting connection with the nozzle 17 wherein the angular inclination of said nozzle to said pistol grip may be incrementally adjusted. The hand tool further includes at least one light 20 positioned to cast light in the direction of the nozzle discharge, the light is preferably a light emitting diode. The hand tool further includes a valve to control said gas pressure and hence the flow rate of the dry ice.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

What is claimed is:

1. A method of cleaning an injection mold, comprising the steps of:
opening the mold;
set a dry ice delivery system operating parameters to produce dry ice granules;
set said dry ice delivery system operating parameters to maintain a gas to dry ice ratio;
set said dry ice delivery system operating parameters to maintain a flow rate;
position a nozzle tip of said dry ice delivery system from said surface.

2. The method of cleaning an injection mold of claim 1 further comprising the step of positioning a mold ejection mechanism to expose a surface to be cleaned;

3. The method of cleaning an injection mold of claim 1 wherein said injection mold is mounted in an injection molding machine and wherein said step of opening said mold is performed by stroking a platen of said machine to maximize the daylight between a first and second mold half.

4. The method of cleaning an injection mold of claim 1 further comprising the step of setting said dry ice delivery system operating parameters to produce dry ice granules preferably within the range of 0.005 to 0.040 inches in diameter.

5. The method of cleaning an injection mold of claim 1 further comprising the step of setting said dry ice delivery system operating parameters to maintain a gas to dry ice ratio preferably between 2.0 and 3.5;

6. The method of cleaning an injection mold of claim 1 further comprising the step of setting said dry ice delivery system operating parameters to maintain said gas flow rate preferably between 3 and 50 SCFM;

7. The method of cleaning an injection mold of claim 1, 2, 3, 4, 5, or 6 further comprising the step of positioning a nozzle tip of said dry ice delivery system preferably between 0.5 and 1.5 inches from said surface.

8. The method of cleaning of claim 7 further comprising the steps of:
set a dry ice delivery system operating parameters to produce dry ice granules that are preferably 0.020 inches in diameter;

9. The method of cleaning of claim 7 further comprising the steps of:
set said dry ice delivery system operating parameters to maintain a gas to dry ice ratio that is preferably 3.0;

10. The method of cleaning of claim 7 further comprising the steps of:
set said dry ice delivery system operating parameters to maintain a flow rate that is preferably 25 SCFM;

11. The method of cleaning of claim 7 further comprising the steps of:
position a nozzle tip of said dry ice delivery system that is preferably 1.0 inches from said surface.

12. The method of cleaning of claim 7 wherein said mold is for the production of preforms.

13. A system for cleaning an injection mold comprising:
a dry ice delivery system;
a hand tool;
said dry ice delivery system provides a flow of dry ice granules in a gas suspension to a discharge port;
said hand tool further includes a nozzle;
said nozzle of said hand tool connected to said discharge port of said dry ice delivery system; wherein:
said dry ice delivery system operable to produce dry ice granules that are preferably between 0.005 and 0.040 inches in diameter;
said dry ice delivery system controllable to maintain a gas to dry ice ratio preferably between 2.0 and 3.5;
said dry ice delivery system controllable to maintain a flow rate preferably between 3 and 50 SCFM.

14. The cleaning system of claim 13 wherein said nozzle of said hand tool is preferably between 0.20 and 0.60 inches in diameter.

15. The cleaning system of claim 13 wherein said nozzle length of said hand tool is preferably between 2.5 and 12.0 inches.

16. The cleaning system of claim 5 wherein said nozzle of said hand tool is preferably 0.40 inches in diameter.

17. The cleaning system of claim 16 wherein said nozzle length of said hand tool is preferably 6.0 inches.

18. The cleaning system of claim 17 wherein said hand tool includes a pistol grip.

19. The cleaning system of claim 18 wherein the angular inclination of said nozzle to said pistol grip is incrementally adjustable.

20. The cleaning system of claim 19 wherein said hand tool includes at least one light positioned to cast light in the direction of the nozzle discharge.

21. The cleaning system of claim 20 wherein said at least one light is a light emitting diode.

22. The cleaning system of claim 21 wherein said hand tool includes a valve to control said gas pressure and hence said flow rate.

23. The cleaning system of claim 22 wherein said mold is for the production of preforms.
